(19) United States
(12) Patent Application Publication
(10) Pub. No.: US 2008/0263533 A1
(43) Pub. Date: Oct. 23, 2008

(54) IMPLEMENTATION OF PATCHES BY A PROCESSING UNIT

(75) Inventors: Thierry Huque, Ramillies (BE); Jean-Louise Modave, Ottignies (BE)

Correspondence Address: STMicroelectronics Inc.;c/o WOLF, GREENFIELD & SACKS, P.C., 600 Atlantic Avenue, BOSTON, MA, 02210-2206, US

(73) Assignee: Proton World International N.V., Zaventem (BE)

(21) Appl. No.: 12/106,174

(22) Filed: Apr. 18, 2008

(30) Foreign Application Priority Data
Apr. 19, 2007 (FR) 07/54568

(51) Int. Cl. G06F 9/44

(52) U.S. Cl. 717/168

(57) ABSTRACT

A method and a circuit of execution, by a processing unit, of at least one patch of at least one first program stored in a first non-reprogrammable non-volatile memory, the patch being stored in a second memory, and wherein: each current address of an instruction of the first program provided by the processing unit is compared with values preloaded in at least one volatile storage element; in case of an identity between the current address and a preloaded value, an interrupt is triggered, this interrupt triggering a search, from a correspondence table, for an address of a patch in the second memory; and the patch is executed.

### BACKGROUND OF THE INVENTION

1. Field of the Invention

The present invention generally relates to digital data processing units and, more specifically, to a central processing unit (CPU) which interprets the program instructions contained in one or several memories external to this processing unit.

The present invention more specifically applies to processing units intended to execute programs contained in a non-reprogrammable non-volatile memory and capable of being corrected or completed by patches.

2. Discussion of the Related Art

In a processing unit, the original programs are stored in a non-reprogrammable non-volatile memory (ROM) on manufacturing of the circuit containing the unit. Such programs are capable of being corrected or completed along the product lifetime by patches loaded into a reprogrammable non-volatile memory or into a RAM (for example, for single-use patches). Such patches are called by the provided original program, to use possible subsequent patches.

A first technique comprises providing, in the original program, instructions for calling a table in a reprogrammable non-volatile memory of the circuit. On execution of the original program, as soon as said program arrives onto one of the reprogrammable memory call instructions, the processing unit checks in this memory for the presence of a patch to be executed.

A disadvantage of this technique is that the points of the original program from which patches can be executed are set in advance from as soon as the product manufacturing. Accordingly, either such patch call points are multiplied, but the original program is then lengthened, or the number of patch input points is limited, but the risk is then taken to have to reproduce a great part of the original program in a patch.

A second technique is described in US patent application n°2006/0107104 and comprises comparing the successive addresses of the program in a ROM on execution thereof with addresses contained in a RAM. The program instructions in the ROM are then replaced on the fly with corrected instructions originating from the RAM. The RAM contains not only the entire patch but also all of the addresses of the main program to be replaced (not only the patch call beginning address).

A problem of this technique is that it requires a large RAM size. Such an on-the-fly replacement of the instructions of the original code with a correction code can thus in practice only be envisaged for microprocessors associated with large RAMs. Further, the replacement technique uses a specific controller which takes up space.

### SUMMARY OF THE INVENTION

The present invention aims at overcoming all or part of the disadvantages of known patch application mechanisms.

An object is a solution requiring no multiple call points in the original program.

Another object more specifically is a solution requiring little RAM.

Another object is a low-bulk solution.

Another object is a solution compatible with a smart card implementation.

To achieve all or part of these objects as well as others, an embodiment of the present invention provides a method of execution, by a processing unit, of at least one patch of at least one first program stored in a first non-reprogrammable non-volatile memory, the patch being stored in a second memory, and wherein:

each current address of an instruction of the first program provided by the processing unit is compared with values preloaded in at least one volatile storage element;

in case of an identity between the current address and a preloaded value, an interrupt is triggered, this interrupt triggering a search, from a correspondence table, for an address of a patch in the second memory; and

the patch is executed.

According to an embodiment, the second memory is a reprogrammable non-volatile memory.

According to an embodiment, the first program comprises an initialization routine executing a loading, into the volatile storage element, of said values from the correspondence table contained in the second memory.

An embodiment of the present invention also provides an electronic circuit comprising:

a program-processing unit;

at least one first non-reprogrammable non-volatile memory;

at least one second memory; and

an element for comparing a current address provided by a program counter of the processing unit with values preloaded into a volatile storage element.

According to an embodiment, said second memory is a reprogrammable non-volatile memory.

The present invention also provides a smart card.

The foregoing and other objects, features, and advantages of the present invention will be discussed in detail in the following non-limiting description of specific embodiments in connection with the accompanying drawings.

### BRIEF DESCRIPTION OF THE DRAWINGS

FIG. 1 shows a smart card of the type to which the present invention applies as an example;

FIG. 2 is a block diagram of an example of architecture of an electronic circuit comprising a digital processing unit;

FIG. 3 is a partial representation of an embodiment;

FIG. 4 illustrates an example of the content of memories associated with the processing unit of FIG. 3; and

FIG. 5 is a functional block diagram of an embodiment.

### DETAILED DESCRIPTION

The same elements have been designated with the same reference numerals in the different drawings.

For clarity, only those steps and elements which are useful to the understanding of the present invention have been shown and will be described. In particular, the functions implemented by the programs, be they original or patches, have not been detailed, the present invention being compatible with any program executed by a processing unit. Similarly, the interpretation of the instructions of a program by the processing unit has not been detailed, the present invention being here again compatible with usual interpretations and exploitations of the instructions of a program.

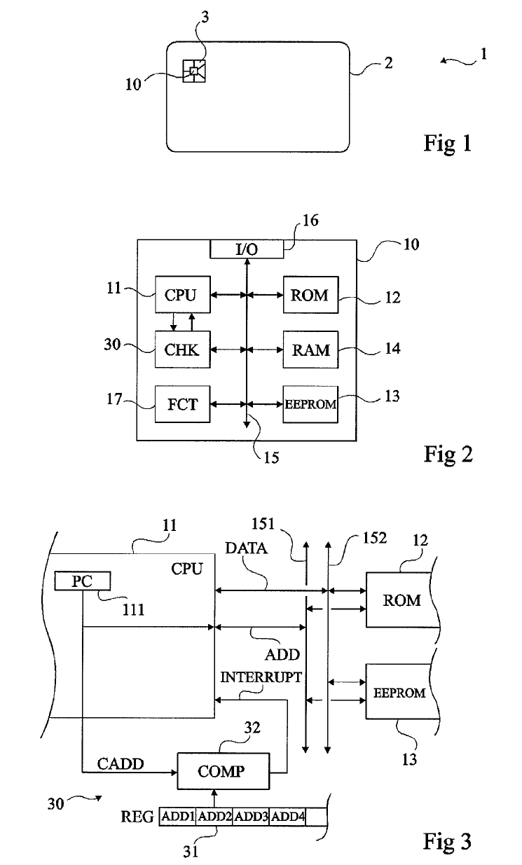

FIG. 1 very schematically shows a smart card 1 of the type to which the present invention applies as an example. Such a card is, for example, formed of a support 2 of plastic matter in or on which is placed an electronic circuit chip 10 capable of communicating with the outside by means of contacts 3 or by means of contactless transceiver elements (not shown). Circuit 10 of the card contains a processing unit capable of executing programs stored in memories generally contained in circuit 10 or in other circuits supported by the card.

FIG. 2 is a block diagram of an embodiment of an electronic circuit 10. This circuit comprises a central processing unit 11 (CPU) capable of executing programs contained in one or several memories. In this example, circuit 10 comprises a non-reprogrammable non-volatile memory 12 (ROM), a reprogrammable volatile memory 13 (EEPROM), and a RAM 14. One or several data, address, and control buses 15 are used as a communication support between the different components of circuit 10 and with an input/output interface 16 (I/O) for communication with or without contact with the outside. Most often, circuit 10 comprises other functions (block 17, FCT) depending on the application. These are, for example, dedicated calculations cells for implementing ciphering or deciphering algorithms.

In the embodiment shown in FIG. 2, circuit 10 further comprises an element 30 (CHK) for detecting a call to a patch.

FIG. 3 is a partial functional block diagram of circuit 10 illustrating an embodiment of element 30.

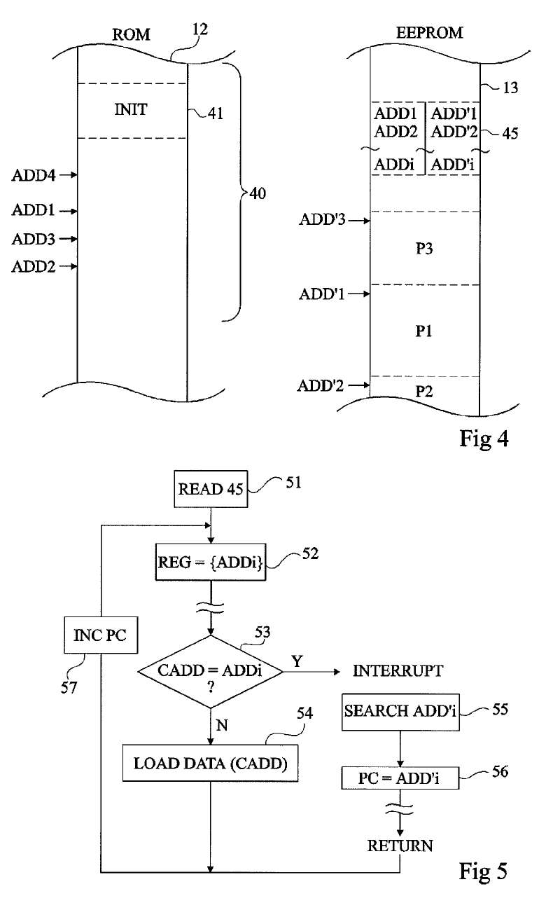

FIG. 4 illustrates an example of the content of a ROM and of a reprogrammable non-volatile memory of the embodiment of FIG. 3.

FIG. 5 is a functional flowchart illustrating an example of operation of the embodiment of FIG. 3.

Processing unit 11 is associated with at least one volatile storage element 31 (for example, a register REG or an area in volatile memory 14) intended to contain addresses of the program(s) (said to be original) stored in non-reprogrammable non-volatile memory 12 (ROM) from which a patch is to be applied. One or several patches are stored in a secondary memory, for example, reprogrammable non-volatile memory 13 (EEPROM). In FIG. 3, address and data buses 151 and 152 between unit 11 and memories 12 and 13 have been shown.

An original program 40 (FIG. 4), stored in ROM 12, comprises an initialization sequence 41 (INIT) to check for the need for a possible patch. Sequence 41 is thus preferentially placed closed to the starting of the original program. The initialization routine checks, by reading (block 51, FIG. 5, READ 45) from a table 45 in secondary memory 13, for the presence of addresses ADDi (i=1, 2, 3, 4, etc.) of the original program in the table. This address table 45 comprises addresses ADD1, ADD2, ADD3, ADD4 of the original program from which patches Pᵢ (P1, P2, P3, etc.) must be called. According to an example, table 45 also comprises addresses ADD'i (ADD'1, ADD'2, ADD'3, ADD'4, etc.) where these patches are stored in the secondary memory (or in another memory). If addresses are present in table 45, the values of the addresses (ADD1, etc.) of the original program are transferred (block 52, REG={ADDi}) into register 31 and the initialization routine is over. As a variation, the patches are called at fixed addresses, agreed beforehand (coded in a ROM). Table 45 then needs not contain any address ADD'i.

On execution of the rest of program 40, central unit 11, when decoding the addresses provided by its program counter 111 (PC) to obtain an instruction, compares (block 53, CADD=ADDI ?) each current address CADD with the values contained in register 31. In case of a lack of identity (output N of block 53), the instruction is loaded from memory 12 to be executed (block 54, LOAD DATA(CADD)). In the opposite case (output Y of block 53), comparison 53 triggers an interrupt (INTERRUPT) delivered to the processing unit.

The processing unit then implements an interrupt processing similar to a usual interrupt processing but for the difference that it is a trap interrupt. The address of program counter 111 is saved, as well as various work registers (not shown). Then, program counter 111 is loaded with an address corresponding to the detected type of interrupt. This address contains a jump to an interrupt routine (contained in memory 12 or 13) and this interrupt routine will search from table 45 to which address ADD'i address ADDi corresponds (block 55, SEARCH ADD'i). Address ADD'i is loaded into the program counter (block 56, PC=ADD'i) for execution of the patch. Once the patch is over, the interrupt is ended (RETURN) and the unit resumes the normal course of the original program by reloading the program counter and the saved work registers. The program then proceeds to the new instruction (block 57, INC PC) which has its address compared with the values of register 31, etc.

An advantage of the described embodiment is that it enables providing, after installation of the original program (and thus after manufacturing), as many patches as desired. Indeed, the number of patches is not limited by addresses predetermined in the original program.

Another advantage is that only a few temporary storage elements (register 31) are required to store addresses of the original program at which the traps should be performed. The patches and the address table may be stored in a reprogrammable non-volatile memory.

Another advantage is that any area of the original program can be corrected or completed.

Another advantage induced by the described implementation is that the size of the original programs stored in the ROM is decreased. Indeed, it is no longer necessary to provide multiple input points towards patches. The cost in program lines only results from the initialization routine.

Another advantage is that this also decreases the size of the patches by making their input points from the original program more versatile.

Register 31 may also be used to verify the progress of the original program by storing in it addresses considered as compulsory transition points in the original program. The interrupt mechanism then points towards a patch which only validates an indicator of a correct progress before returning to the original program. At the end of the processing of the original program, if the different addresses contained in the register have not been processed, the circuit implements an exception processing (for example, a blocking or an alert). As a variation, the patch carries out several processings for verifying the progress of the program and/or the state of the process.

Specific embodiments of the present invention have been described. Various alterations and modifications will occur to those skilled in the art. In particular, the practical implementation, be it in software or hardware fashion, is within the abilities of those skilled in the art based on the functional indications given hereabove, especially as concerns the selection of the addresses used as a possible verification of the progress of the program.

Further, although the present invention has been described in relation with an example where the patches are stored in a non-volatile memory, it also applies to the case where the secondary memory is a volatile memory in which all or part of the patches are contained.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A method of execution, by a processing unit, of at least one patch of at least one first program stored in a first non-reprogrammable non-volatile memory, the patch being stored in a second memory, wherein:
each current address of an instruction of the first program provided by the processing unit is compared with values preloaded in at least one volatile storage element;
in case of an identity between the current address and a preloaded value, an interrupt is triggered, this interrupt triggering a search, from a correspondence table, for an address of a patch in the second memory; and
the patch is executed.

2. The method of claim 1, wherein the second memory is a reprogrammable non-volatile memory.

3. The method of claim 1, wherein the first program comprises an initialization routine executing a loading, into the volatile storage element, of said values from the correspondence table contained in the second memory.

4. An electronic circuit comprising:
a program processing unit;
at least one first non-reprogrammable non-volatile memory;
at least one second memory; and
an element for comparing a current address provided by a program counter of the processing unit with values preloaded into a volatile storage element, to implement the method of claim 1.

5. The circuit of claim 4, wherein said second memory is a reprogrammable non-volatile memory.

6. A smart card comprising the circuit of claim 4.
